(19) United States
(12) Patent Application Publication
(10) Pub. No.: US 2026/0095972 A1
(43) Pub. Date: Apr. 2, 2026

(54) METHOD AND DEVICE RELATED TO IMPROVEMENT OF USER EQUIPMENT ASSISTANCE INFORMATION IN MOBILE COMMUNICATION SYSTEM

(71) Applicant: SAMSUNG ELECTRONICS CO., LTD., Suwon-si, Gyeonggi-do (KR)

(72) Inventors: Seungbeom JEONG, Suwon-si (KR); Sangyeob JUNG, Suwon-si (KR)

(21) Appl. No.: 19/111,669

(22) PCT Filed: Sep. 18, 2023
(86) PCT No.: PCT/KR2023/014027

§ 371 Date: Mar. 13, 2025

(30) Foreign Application Priority Data
Sep. 19, 2022 (KR) 10-2022-0117635

(51) Int. Cl. H04W 76/27; H04W 24/10; H04W 28/02

(52) U.S. Cl. CPC H04W 76/27; H04W 24/10; H04W 28/0215

(57) ABSTRACT

The method of user equipment (UE) of the present disclosure may comprise the steps of: transmitting, to a base station, information about a capability of the UE supporting provision of first UE assistance information (UAI); and receiving, from the base station, configuration information for reporting of the first UAI; and starting, on the basis of the configuration information for the reporting of the first UAI, transmission of a first UAI message for the reporting of the first UAI, to the base station, and starting a first timer related to the reporting of the first UAI.

### TECHNICAL FIELD

The disclosure relates to a method and an apparatus for providing UE assistance information in a mobile communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DETAILED DESCRIPTION OF THE INVENTION

### Technical Problem

The disclosure provides a method and an apparatus for improving UE assistance information.

### Technical Solution

A method of a user equipment (UE) in a wireless communication system according to an embodiment of the disclosure may include transmitting information on a capability of the UE supporting provision of first user equipment (UE) assistance information (UAI) to a base station, receiving configuration information of the UE for reporting the first UAI from the base station, and initiating transmission of a first UAI message for reporting the first UAI to the base station, based on the configuration information for reporting the first UAI, and starting a first timer related to the reporting of the first UAI.

As an embodiment, when the first UAI is for overheating of the UE, the first UAI may include information indicating a degree of overheating of the UE.

As an embodiment, the information indicating the degree of overheating of the UE may include an indicator indicating whether current temperature of the UE is higher than a predefined temperature threshold or an indicator indicating whether the current temperature of the UE is higher than the predefined temperature threshold for a predefined time threshold.

As an embodiment, at least one of the temperature threshold or the time threshold may be configured by the base station.

As an embodiment, the method may further include transmitting a second UAI message for reporting preference information for a length of the first timer to the base station before the first timer expires and receiving configuration information for the length of the first timer from the base station, wherein the length of the first timer may be configured based on the second UAI message.

As an embodiment, the method may further include starting a second timer related to autonomous transition of the UE to a radio resource control (RRC) idle mode or an RRC inactive mode, along with starting the first timer.

As an embodiment, the method may further include determining whether to autonomously transition to a radio access state to the RRC IDLE mode or the RRC INACTIVE mode when the second timer expires.

As an embodiment, the method may further include transmitting a third UAI message for reporting preference for a configuration of the first UAI to the base station and receiving configuration information for configuring the first UAI from the base station.

A user equipment (UE) in a wireless communication system according to an embodiment of the disclosure may include a transceiver and at least one processor, wherein the processor may be configured to transmit information on a capability of the UE supporting provision of first user equipment (UE) assistance information (UAI) to a base station, receive configuration information for reporting the first UAI from the base station, initiate transmission of a first UE assistance information message (UAI message) for reporting the first UAI to the base station, and start a first timer related to the reporting of the first UAI.

A method of a base station in a wireless communication system according to an embodiment of the disclosure may include receiving information on a capability of a user equipment (UE) supporting provision of first user equipment (UE) assistance information (UAI) from the UE, transmitting configuration information for reporting the first UAI to the UE, and receiving a first UAI message for reporting the first UAI from the UE, based on the configuration information for reporting the first UAI, wherein a first timer related to the reporting of the first UAI may start when transmission of the first UAI message is initiated.

As an embodiment, when the first UAI is for overheating of the UE, the first UAI may include information indicating a degree of overheating of the UE.

As an embodiment, the method of the base station may further include receiving a second UAI message for reporting preference information for a length of the first timer from the UE before the first timer expires and transmitting configuration information for the length of the first timer to the UE, wherein the length of the first timer may be configured based on the second UAI message.

A base station in a wireless communication system according to an embodiment of the disclosure may include a transceiver and at least one processor, wherein the at least one processor may be configured to receive information on a capability of a user equipment (UE) supporting provision of first user equipment (UE) assistance information (UAI) from the UE, transmit configuration information for reporting the first UAI to the UE, and receive a first UAI message for reporting the first UAI from the UE, based on the configuration information for reporting the first UAI, wherein a first timer related to the reporting of the first UAI may start when transmission of the first UAI message is initiated.

As an embodiment, when the first UAI is for overheating of the UE, the first UAI may include information indicating a degree of overheating of the UE.

As an embodiment, the at least one processor of the base station may be configured to receive a second UAI message for reporting preference information for a length of the first timer from the UE before the first timer expires and transmit configuration information for the length of the first timer to the UE, wherein the length of the first timer may be configured based on the second UAI message.

### Advantageous Effects

According to the disclosure, it is possible to provide improved UE assistance information.

### BRIEF DESCRIPTION OF DRAWINGS

FIG. 1 illustrates a structure of a next-generation mobile communication system.

FIG. 2 is a diagram illustrating radio access state transition in a next-generation mobile communication system.

FIG. 3 is a diagram illustrating a procedure in which the UE transmits UE assistance information to the gNB in the next-generation mobile communication system.

FIG. 4 is a diagram illustrating a method by which the UE reports UE assistance information according to an embodiment of the disclosure.

FIG. 5 is a diagram illustrating a method by which the UE reports UE preference to a prohibit timer associated with UE assistance information according to an embodiment of the disclosure.

FIG. 6 is a diagram illustrating a method by which the UE processes the same UE assistance information (UAI) according to an embodiment of the disclosure.

FIG. 7 is a diagram illustrating a procedure in which the UE autonomously transitions to the RRC_IDLE mode (or RRC_INACTIVE) when a timer A expires according to an embodiment of the disclosure.

FIG. 8 is a diagram illustrating a procedure in which the UE restarts and terminates the timer A according to an embodiment of the disclosure.

FIG. 9 is a diagram illustrating a procedure in which the UE transmits a UAI feature for which the UE needs to be configured to the gNB according to an embodiment of the disclosure.

FIG. 10 is a block diagram illustrating a structure of a UE according to an embodiment of the disclosure.

FIG. 11 is a block diagram illustrating a structure of a base station according to an embodiment of the disclosure.

### MODE FOR CARRYING OUT THE INVENTION

In describing the disclosure below, a detailed description of known functions or configurations incorporated herein will be omitted when it is determined that the description may make the subject matter of the disclosure unnecessarily unclear.

For the same reason, in the accompanying drawings, some elements may be exaggerated, omitted, or schematically illustrated.

It will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The instructions which execute on a computer or other programmable data processing apparatus to cause a series of operational steps to be performed on the computer or other programmable data processing apparatus to produce a computer implemented process may provide steps for implementing the functions specified in the flowchart block(s).

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the following description, 5G (NR) or a 5G (NR) system may be described by way of example, but the embodiments of the disclosure may also be applied to other communication systems having similar technical backgrounds or channel types. In addition, based on determinations by those skilled in the art, the disclosure may also be applied to other communication systems through some modifications without significantly departing from the scope of the disclosure.

Hereinafter, embodiments of the disclosure will be described with reference to the accompanying drawings.

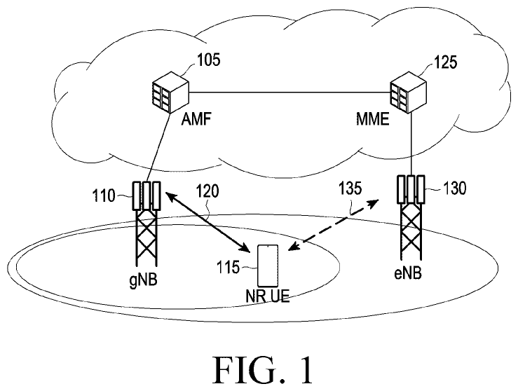

FIG. 1 illustrates a structure of a next-generation mobile communication system.

For the sake of descriptive convenience, as the next-generation mobile communication system in the disclosure, a 5G (new radio, NR) system will be described by way of example, but embodiments are not limited thereto and, for example, the next-generation mobile communication system may be a beyond 5G system, e.g., a 6G system.

Referring to FIG. 1, a radio access protocol of the next-generation mobile communication system (new radio, NR) may include a next-generation base station (new radio node B, hereinafter gNB or base station) 110 and an access and mobility management function (AMF) (new radio core network) 105. A user equipment (new radio user equipment, hereinafter NR UE or terminal or UE) 115 may access an external network via the gNB 110 and the AMF 105.

In FIG. 1, the gNB 110 may correspond to an evolved node B (eNB) of a conventional LTE system. As illustrated by reference numeral “120” in FIG. 1, the gNB 110 is connected to the NR UE 115 through a radio channel and may provide outstanding services as compared to a conventional node B. In the next-generation mobile communication system, since all user traffic is serviced through a shared channel, a device that collects state information, such as buffer statuses, available transmit power states, and channel states of UEs, and performs scheduling accordingly s required, and the gNB 110 may serve as the device. In general, one gNB 110 may control multiple cells. In order to implement ultrahigh-speed data transfer beyond the current LTE, the next-generation mobile communication system may provide a wider bandwidth than the existing maximum bandwidth, may employ an orthogonal frequency division multiplexing (hereinafter referred to as OFDM) as a radio access technology, and may additionally integrate a beamforming technology therewith. Furthermore, the next-generation mobile communication system may employ an adaptive modulation & coding (hereinafter referred to as AMC) scheme for determining a modulation scheme and a channel coding rate according to a channel state of a UE.

The AMF 105 may perform functions such as mobility support, bearer configuration, and QoS configuration. The AMF 105 is a device (entity) responsible for various control functions as well as a mobility management function for a UE, and may be connected to multiple base stations. In addition, the next-generation mobile communication system may interwork with the existing LTE system, and the AMF 105 may be connected to an MME 1a-25 via a network interface. An MME 125 may be connected to an eNB 130 that is an existing base station. The UE 115 supporting LTE-NR dual connectivity may transmit/receive data while maintaining connections to both the gNB 110 and the eNB 130.

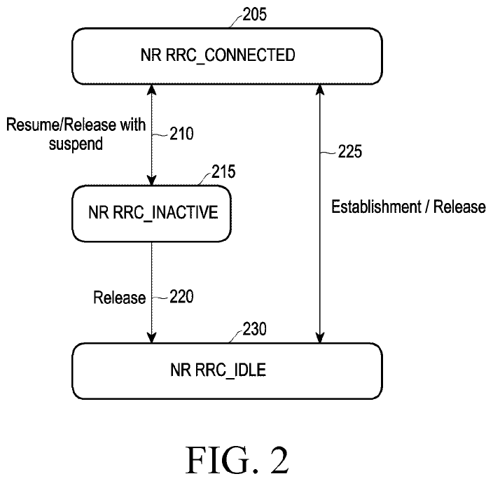

FIG. 2 is a diagram illustrating radio access state transition in a next-generation mobile communication system.

Referring to FIG. 2, the next-generation mobile communication system may have three radio access states (radio resource control (RRC) states).

A connected mode (RRC_CONNECTED) 205 is a radio access state in which a user equipment (UE) can transmit and receive data. An idle mode (RRC_IDLE) 230 is a radio access state in which the UE monitors whether paging is transmitted to the UE itself. The two modes are radio access states applied to the conventional LTE system, and detailed technology thereof may be the same as that of the conventional LTE system.

An inactive (RRC_INACTIVE) radio access state 215 is newly defined in the next-generation mobile communication system. In the radio access state 215, UE context is maintained in a gNB and the UE, and RAN-based paging may be supported. In the disclosure, the radio access state 215 may be referred to as an inactive (RRC_INACTIVE) radio access state, an INACTIVE radio access state, an INACTIVE state, or an inactive mode.

The new radio access state 215 may have one or more of the following characteristics.
Cell re-selection mobility;
CN-NR RAN connection (both C/U-planes) has been established for UE;
The UE AS context is stored in at least one gNB and the UE;
Paging is initiated by NR RAN;
RAN-based notification area is managed by NR RAN;
NR RAN knows the RAN-based notification area which the UE belongs to;

The new INACTIVE radio access state 215 may transition to the connected mode or the idle mode through a specific procedure. As indicated by reference numeral 210, transition is performed from the INACTIVE mode 215 to the connected mode 205 according to a resume process, and transition may be performed from the connected mode 205 to the INACTIVE mode 215 through a release procedure including suspend configuration information. The procedure may include an operation (or step) in which one or more RRC messages are transmitted and received between the UE and the gNB and may be constituted by one or more steps. As indicated by reference numeral 220, through the release procedure after resume, transition can be performed from the INACTIVE mode 215 to the idle mode 230.

The transition between the connected mode 205 and the idle mode 230 may follow the conventional LTE technology. As indicated by reference numeral 225, through an establishment or release procedure, transition between the modes may be performed.

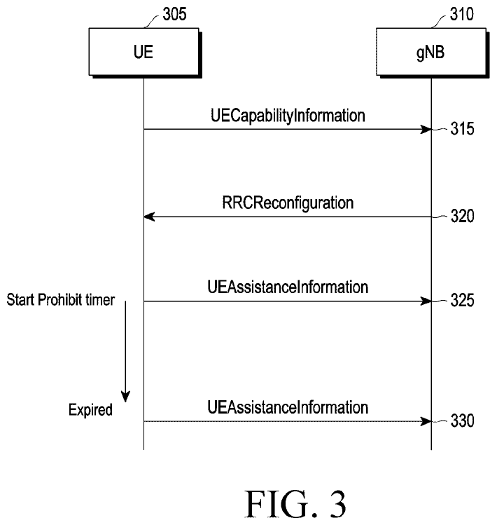

FIG. 3 is a diagram illustrating a procedure in which the UE transmits UE assistance information to the gNB in the next-generation mobile communication system.

The UE may transmit information on at least one UAI feature to the gNB or the network through a UE assistance information (UAI) message. In the disclosure, the information on the UAI feature may be referred to as UAI feature information, feature information, UE assistance information, UAI, or assistance information.

One UAI message may include information on one or more UAI features. The UE may report one or more of the following UAI features (or information on UAI features) to the gNB through the UAI message.
1) Delay budget reporting including adjustment of the length of a DRX cycle of a connected mode which the UE desires
2) UE overheating-related information
3) UE in-device coexistence (IDC)-related information
4) UE preference information for DRX parameter information to reduce UE energy
5) UE preference information for a maximum aggregated bandwidth to reduce UE energy
6) UE preference information for the maximum number of secondary component carriers to reduce UE energy
7) UE preference information for the maximum number of MIMO layers to reduce UE energy
8) UE preference information for a minimum scheduling offset of cross-slot scheduling to reduce UE energy
9) UE preference information for RRC modes
10) Configured grant-related assistance information for NR sidelink
11) UE preference information for reception of reference time information
12) UE preference information for an FR2 uplink (UL) gap
13) UE preference information for an RRC state transition to escape from a connected mode (RRC_CONNECTED) for a multiple universal subscriber identity modules (MUSIM) operation
14) UE relaxation state information for performance of radio link monitoring (RLM) measurement
15) UE relaxation state information for performance of beam failure detection (BFD) measurement
16) Availability information of data mapped to radio bearers that are not configured for small data transmission (SDT)
17) UE preference information related to secondary cell group (SCG) deactivation
18) Information indicating whether the UE has uplink data to be transmitted for a DRB having no master cell group (MCG) radio link control (RLC) bearer in a deactivated state of the SCG
19) A change in a satisfaction state for a radio resource management (RRM) measurement relaxation condition

Referring to FIG. 3, in operation 315, a UE 305 may report UAI support capability of the UE for at least one UAI feature to a gNB 310 through a UE capability information message. In an embodiment, the UE 305 may report the UAI support capability of the UE for each UAI feature to the gNB 310 through the UE capability information message.

In operation 320, the gNB 310 receiving the same may indicate/configure UAI reporting for one or more UAI features to the UE 305. In an embodiment, the gNB 310 may indicate/configure UAI reporting for each UAI feature to the UE 302 by using an RRCReconfiguration message. For example, when the UE 305 reports the fact that UAI feature 1 (for example, overheating UAI feature) is supported to the gNB 310 through a UE capability information message, the gNB 310 may indicate/configure a report on UAI (for example, overheating UAI) for UAI feature 1 to/in the corresponding UE 305. However, when the gNB 310 does not desire, the report on the UAI for the corresponding UAI feature may not be indicated/configured to/in the UE 305.

In an embodiment, the gNB 310 may not only indicate/configure the report on the UAI for each UAI feature to the UE 305 through UAI-related configuration information within the RRCReconfiguration message but also configure a prohibit timer (PT). The gNB 310 may also configure the length of the PT.

In operation 325, the UE 305 may identify whether a condition for initiating transmission of the UAI message (UEAssistanceInformation message) is satisfied in order to provide (or report) UAI. In an embodiment, when some or all of the following conditions are satisfied for each feature (UAI feature), the UE 305 may transmit the UAI message (UEAssistanceInformation message) to the gNB.
1) The case where the UE supports the corresponding UAI feature
2) The case where the UE receives a configuration of setup for the corresponding UAI feature from the gNB (for example, the case where setup is made through the RRCReconfiguration message)
3) The case where the UE never reports information on the corresponding UAI feature to the gNB
4) The case where information (for example, preference or UE state) which the UE previously transmitted for the corresponding UAI feature to the gNB through the UAI message is newly changed
5) The case where the UE satisfies a transmission condition for the corresponding UAI feature This may vary depending on each UAI feature.
6) The case where the UE is not running the prohibit timer for the corresponding UAI feature

The condition that the UE should satisfy to transmit UAI may vary depending on each UAI feature.

The UE may transmit the UAI message for the UAI feature through the condition and start the PT for the corresponding UAI feature (when the PT is configured) at the same time. For example, when the condition for the corresponding UAI feature is satisfied, the UE may initiate transmission of the UAI message including UAI for the corresponding UAI feature and start the PT for the corresponding UAI feature at the same time.

As described in condition 6, the UE cannot transmit the UAI message for the corresponding UAI feature while the PT is running. Since frequent transmission of the UAI message by the UE may cause radio source waste, energy waste, and computing resource waste of the gNB and the UE, and thus this may be an action to prevent the waste.

In operation 330, the UE 305 may transmit the UAI message for the corresponding UAI feature after the PT expires. For example, when the PT expires and some or all of the conditions are satisfied, the UE 305 may transmit the UAI message for the corresponding UAI feature again.

When a configuration for the corresponding feature (UAI feature) is released (for example, Upon releasing maxCC-PreferenceConfig during the connection re-establishment/resume procedures) or the UE receives a configuration of release for the corresponding UAI feature from the gNB (for example, upon receiving maxCC-PreferenceConfig set to release), running of the PT may stop.

Hereinafter, various embodiments for UAI enhancement are described as examples with reference to each drawing. Embodiments (for example, first to fourth embodiments) described below may be combined within the scope in which the embodiments do not contradict each other.

### FIRST EMBODIMENT

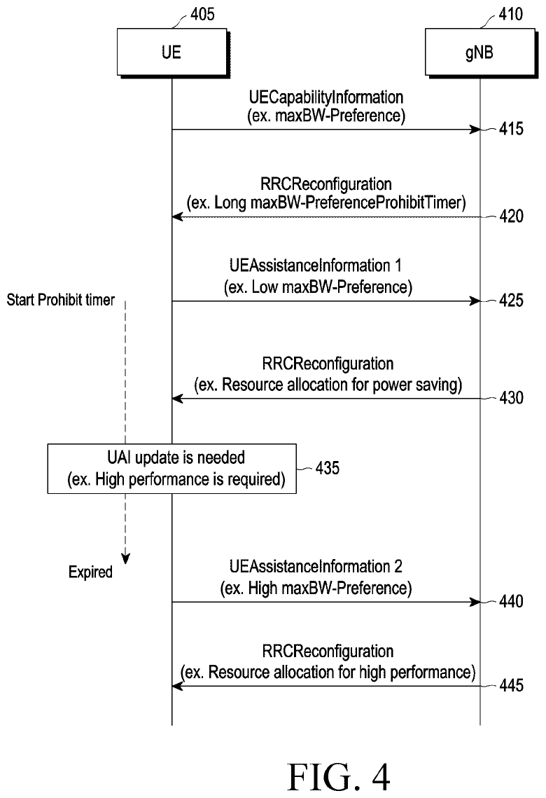

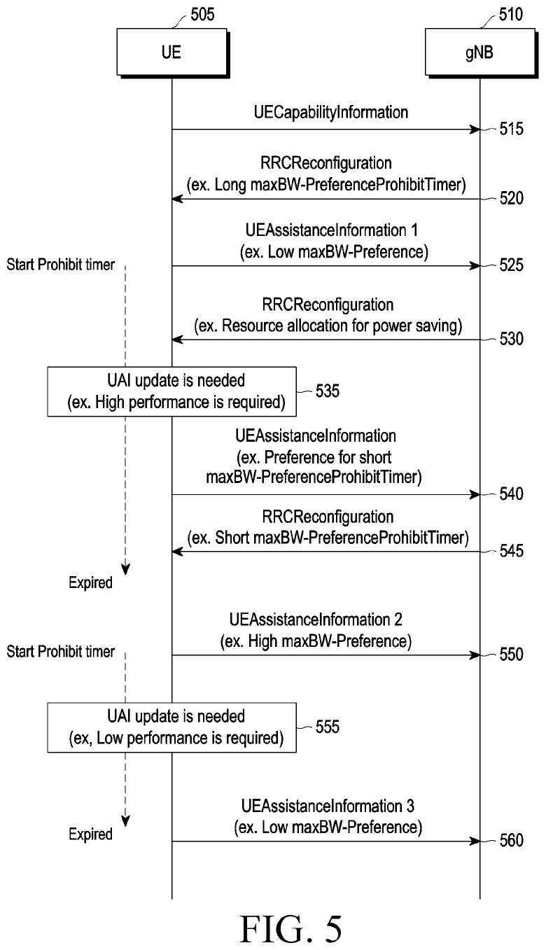

Hereinafter, a first embodiment for UAI enhancement is described with reference to FIGS. 4 to 5.

FIG. 4 is a diagram illustrating a method by which the UE reports UE assistance information according to an embodiment of the disclosure.

In the embodiment of FIG. 4, for convenience of description, the case where UE assistance information (UAI) is assistance information for informing the gNB of maximum bandwidth preference of the UE is described as an example, but the embodiment is not limited thereto and the same description may be applied to UAI for the various UAI features.

Referring to FIG. 4, in operation 415, a UE 405 may report UE capability to a gNB 410 through a UE capability information (UECapabilityInfromation) message. In an embodiment, the UE 405 may insert UE support capability for a specific UAI feature (for example, a maximum aggregated bandwidth) or for each UAI feature into the UE capability information message and transmit the UE capability information message to the gNB 410. For example, in order to inform of the UE support capability for the UAI feature (for example, the maximum aggregated bandwidth), the UE 405 may configure a parameter (for example, maxBW-Preference-r16) related to the corresponding UAI feature within the UECapabilityInfromation message as “supported” and transmit the same to the gNB 410, so that the UE 405 may inform the gNB 410 of the fact that the report on the maximum aggregated bandwidth that is preferred for the purpose of energy saving is supported.

In operation 420, the gNB 410 receiving the content of supporting (capability) of the UE 405 may configure UAI feature transmission (for example, the report on the maximum aggregated bandwidth) in the UE 405. To this end, the gNB 410 may use an RRC reconfiguration message. In an embodiment, the gNB 410 may provide a configuration for reporting the corresponding UAI for a specific UAI feature (for example, a maximum aggregated bandwidth) or for each UAI feature to the UE 405 by using the RRC reconfiguration message. For example, in order to report the maximum aggregated bandwidth, setup of the parameter MaxBW-PreferenceConfig-r16 within the RRC reconfiguration message may be indicated. When each UAI feature is configured (for example, setup of MaxBW-PreferenceConfig is indicated), the gNB 410 may configure the length of the PT (For example, maxCC-PreferenceProhibitTimer) for the corresponding UAI feature, so as to indicate the configuration of the PT of the corresponding UAI feature to the UE 405.

In operation 425, the UE 405 receiving the configuration from the gNB 410 may transmit a UE assistance information (UEAssistanceInformation) message for the corresponding UAI feature (for example, the maximum aggregated bandwidth) when a specific condition is satisfied (for example, some or all of the above-described conditions are satisfied in connection with operation 325 of FIG. 3). For example, the UE 405 does not need the high performance to transmit UAI message 1 (for example, when application or programs being executed are small) and thus may report that a maximum aggregated bandwidth having a low value is preferred to save energy to the gNB 410 (for example, by configuring low maxBW-Preference-r16). Also, the UE 405 may start running the configured PT, and the running of the PT may be maintained as much as the length of the PT configured by the gNB 410 unless a special stop condition of the timer is satisfied, and may expire thereafter.

In operation 430, the gNB 410 may configure new network settings (for example, settings for a low aggregated bandwidth and to further save energy (for example, (re) allocation of resources to reduce power) in accordance with UE preference or information according to the received UAI message.

However, as indicated by reference 435 of FIG. 4, UE preference or information which the UE 405 reported to the gNB 410 through the UAI message may be changed. For example, network settings may be needed to process suddenly a large amount of radio resources (for example, many aggregated bandwidths) or a large amount of data by the UE 405 receiving the settings for the low aggregated bandwidth and to further save energy and performing the operation. That is, the UE 405 may be required to have the high performance. For example, the user abruptly starts a high-performance program (for example, a 3D game), and thus the high performance of the UE 405 may be needed.

However, at a time point as indicated by reference numeral 435 of FIG. 4, that is, at a time point at which the PT for the corresponding UAI feature (for example, the maximum aggregated bandwidth) is running, the UE 405 cannot transmit UAI indicating preference for higher performance (for example, preference of a large aggregated bandwidth) to the gNB 410. Accordingly, the network cannot recognize the face that the UE 405 needs high performance and thus cannot provide network settings suitable therefor.

The UE 405 can transmit the UAI indicating preference for the higher performance (for example, large aggregated bandwidth) to the gNB 410 after the PT expires as in operation 440, and the gNB 410 may transmit the network settings (for example, (re)allocation of resources) for the higher performance to the UE 405 too later as in operation 445. That is, until the PT expires, the gNB 410 may not provide necessary network settings to the UE 405. As described above, according to the procedure (method) of FIG. 4, when the PT is running even though the UE preference or information is changed, the UE 405 cannot report the changed content to the gNB 410, and the gNB 410 may not provide the UE 405 with timely network settings according thereto. Accordingly, it may be required to consider a method of solving the technical problem.

FIG. 5 is a diagram illustrating a method by which the UE reports UE preference to a prohibit timer associated with UE assistance information according to an embodiment of the disclosure.

In the embodiment of FIG. 5, like the embodiment of FIG. 4, for convenience of description, the case where UE assistance information (UAI) is assistance information for informing the gNB of maximum bandwidth preference of the UE is described as an example, but the embodiment is not limited thereto and the same description may be applied to UAI for the various UAI features.

Meanwhile, description indicated by reference numerals 505 to 535 of FIG. 5 may refer to description indicated by reference numerals 405 to 435 of FIG. 4. For example, the content of operations 415 to 435 of FIG. 4 may be equally applied to operations 515 to 535 of FIG. 5 within the scope that they do not contradict the description of FIG. 5 below, and the corresponding description may refer to the description of FIG. 4.

Referring to FIG. 5, in operation 515, a UE 505 may report, to a gNB 510, whether to support capability of transmitting (or providing) preference for the length of the PT for a specific UAI feature (for example, maximum aggregated bandwidth) or for each UAI feature to the gNB. To this end, the UE 505 may use a UE capability information (UECapabilityInfromation) message. For example, the UE 505 may configure a PT-related parameter of the corresponding UAI feature (for example, maximum aggregated bandwidth) within the UECapabilityInfromation message as “supported” and transmit the same to the gNB 510, so that the UE 505 may inform the gNB 510 that transmission of preference for the length of the PT related to the report on the UAI (for example, report on the maximum aggregated bandwidth) for the corresponding UAI feature is supported.

In an embodiment, by using the UECapabilityInformation message, the UE 505 may transmit together capability of supporting the report itself on UAI (for example, maxBW-Preference) on the UAI feature and capability of supporting the report (transmission) on preference for the length of the PT (for example, maxBW-PreferenceProhibitTimer) related to the report on the corresponding UAI.

In operation 520, the gNB 510 may set up or release the configuration indicating transmission of preference for the length of the PT for a specific UAI feature (for example, maximum aggregated bandwidth) or for each UAI feature. In an embodiment, the gNB 510 may provide the configuration for transmission of (report on) preference for the length of the corresponding PT to the UE 405 by using an RRC reconfiguration message. In an embodiment, the configuration for transmission of (report on) preference for the length of the PT (first PT) may include a configuration for an additional PT (second PT) for transmission of preference for the length of the corresponding PT.

At a time point 535 of FIG. 5, that is, at a time point at which the PT is running, the UE 505 may not transmit UE preference or information updated for the corresponding UAI feature (for example, maximum aggregated bandwidth).

Instead of this, as illustrated in operation 540, the UE 505 may transmit preference for the length of the PT of the corresponding UAI feature (for example, maximum aggregated bandwidth) to the gNB. For example, the UE 505 may indicate the length of the PT preferred by the UE for the corresponding UAI feature (or for each feature) through the UAI message and transmit the UAI message to the gNB 510. For example, the UE 505 may insert information on the length of the PT preferred by the UE for the corresponding UAI feature (or for each feature) into the UAI message and transmit the UAI message to the gNB 510. As an embodiment, the information on the preferred length of the PT may be information indicating the preferred length of the PT as an explicit value or information indicating whether a length shorter than the currently configured length of the PT is desired (or a longer length is desired).

For example, as described in operation 540, when the UE 505 cannot transmit UE preference or information updated for the corresponding UAI feature (for example, maximum aggregated bandwidth) at the time point 535 of FIG. 5, the gNB 510 may be required to frequently update and report UAI in the future through transmission of the fact that the shorter length of the PT is preferred for the corresponding UAI feature to the gNB 510. Accordingly, the gNB 510 may configure, in the UE 505, a new length of the PT shorter than the length of the PT conventionally configured in the UE as described in operation 545.

On the other hand, when the UE 515 determines that the length of the PT no longer needs to be shorter or when a longer length of the PT is preferred (for example, when it is determined that UE preference and information are unlikely to be updated or it is determined that energy saving is needed for UAI message transmission), a request for the longer length of the PT for the corresponding UAI feature may be made to the gNB 510. Accordingly, the gNB 510 may configure, in the UE 505, the new length of the PT longer than the length of the PT conventionally configured in the UE.

When the running timer (PT) expires or ends (for example, when the UE receives release of the configuration of the corresponding UAI feature), the UE 505 may transmit a new UAI message (for example, UAI message 2) in operation 550. At this time, the UE 505 may transmit UE preference or information (for example, information indicating that a high maximum aggregated bandwidth is preferred) changed for the corresponding UAI feature to the gNB 510.

In operation 555, the UE 505 may start the PT by using the PT length newly configured by the gNB 510 right after UAI message 2 is transmitted. For example, when the UE 505 makes a request for the short length of the PT to the gNB 510 in operation 540 in order to rapidly update and report UAI and accordingly receives the configuration of the shorter PT length from the gNB 510 in operation 545, the UE 505 may report the updated UE preference and information to the gNB 510 faster than before in operation 560 because the PT expires earlier than before when the UE preference or information is changed again in operation 555. Accordingly, the gNB may rapidly reflect UE preference and information and quickly provide the UE with new network settings.

As an embodiment of the disclosure, the UE may indicate the PT length preferred for a specific UAI feature or for each UAI feature as an explicit value. Alternatively, the UE may indicate whether a value shorter (or longer) than the currently configured value (for example, PT length value) is desired for the specific UAI feature or for each UAI feature.

As an embodiment of the disclosure, capability of reporting (transmitting or providing) the PT length preferred for the specific UAI feature or for each UAI feature may be defined as UE capability. The corresponding UE may not be mandatory to all UEs, and thus the UE may report whether the capability is supported for the specific UAI feature or for each UAI feature through a UE capability message.

As an embodiment of the disclosure, the gNB or the network (according to whether the UE supports the capability) may indicate, to the UE, whether the PT length preferred for the specific UAI feature or for each UAI feature may be reported. Even though the UE supports the same, the gNB cannot use or may not desire to use the information, and thus an indicator therefor may be needed.

As an embodiment of the disclosure, the gNB or the network may further configure an additional PT (second PT) for reporting the length of the PT (first PT) preferred for the specific UAI feature or for each UAI feature in the UE. As an embodiment, the additional PT may start when transmission of a UAI message for reporting the PT length preferred by the UE is initiated.

### SECOND EMBODIMENT

Meanwhile, as described above, UE overheating-related UAI may be used as one UAI (UAI feature). However, when the conventional UAI method is used, information indicating a degree or seriousness of overheating is not included in UAI for overheating (overheating UAI feature) (overheating UAI), so that the gNB or the network cannot know the degree or seriousness of UE overheating. Hereinafter, methods of solving the technical problem are described by way of examples.

First, with reference to FIGS. 3 to 5, a procedure in which the UE provides overheating UAI feature (or overheating assistance information) is described as an example.

In operation 315, 415, or 515, the UE may report whether an overheating UAI feature is supported to the gNB through an indicator (for example, overheatingInd). As an embodiment, overheatingInd may be included in a UE capability information message, and a value of “supported” may be configured to inform that the UE supports the overheating UAI feature.

In operation 320, 420, or 520, the gNB may set up or release the overheating UAI feature through OverheatingAssistanceConfig, and configure a PT for the overheating UAI feature in the UE (by configuring the length of the PT) during setup. As an embodiment, OverheatingAssistanceConfig may be included in an RRC reconfiguration message.

In operation 325/330, 425/440, or 425/450, when overheating is detected or previously transmitted overheating information is changed, the UE receiving the setup of the overheating UAI feature may start running the PT and simultaneously transmit the overheating UAI if the corresponding PT is not running. As an embodiment, the overheating UAI may be included in a UE assistance information message (UAI message).

As an embodiment, the overheating UAI included in the UAI message (for example, information that can be included in an OverheatingAssistance IE of the UAI message) may include a maximum aggregated bandwidth, the maximum number of component carriers (CCs), and/or the maximum number of MIMO layers. The provision of the overheating UAI may be to solve UE overheating by making a request for configuring resources having a value smaller than the values to the network. The gNB may remove the UE overheating by (re)configuring resources having the value smaller than the corresponding values by using the overheating UAI provided by the UE. When the overheating problem is solved, the UE may inform the gNB that the overheating problem is solved by not including (by indicating absence of) the overheating UAI in the OverheatingAssistance IE.

Meanwhile, when the UE indicates the maximum aggregated bandwidth, the maximum number of component carriers (CCs), and the maximum number of MIMO layers preferred by the UE itself, the gNB may or may not configure resources having the value smaller than the values. Since the gNB may receive the overheating UAI from a plurality of UEs and it may be inefficient for the network operation to change/configure the network settings in accordance with requests from all UEs, the operation mandatory to the gNB (for example, the operation of changing the network settings in accordance with overheating UAI requests from all UEs) is not defined by the standard document (for example, 3GPP standard document), and the gNB may ignore the UE overheating problem.

However, the UE overheating problem may directly lead to user safety issues. For example, the user may suffer burns without even knowing it if the user is exposed to the overheating UE for a long period of time. Accordingly, the gNB may need to handle overheating-related information transmitted through UAI with higher priority than other UAI features. However, in the conventional UAI method, the gNB could not know the degree or seriousness of overheating of UEs and simply receive only network settings (a maximum aggregated bandwidth, the maximum number of CCs, the maximum number of MIMO layers, and the like) preferred by the UEs.

If the gNB can know the overheating degree or seriousness of UEs, it may be possible to more efficiently manage and operate the network. For example, the gNB may immediately transmit, to UEs with severe overheating, network setting information in accordance with the network settings preferred by the UEs (for example, for safety of users). On the other hand, the gNB may ignore network settings of UEs of which overheating is detected but is not severe (for example, in order to reduce overhead for the network operation by the gNB).

The disclosure proposes a method by which the UE may transmit (or inform of) a degree (seriousness) of overheating to the gNB. To this end, one or a combination of the following methods may be used. For example, method 5 may be combined with method 4.

Method 1) The UE may report whether the current temperature (Tcurrent) of the UE is higher than a specific temperature threshold (TThreshold) to the gNB. When the current temperature of the UE is higher than the temperature threshold, the UE may configure a specific reporting indicator as true or present and report the same to the gNB. On the other hand, when the current temperature of the UE is lower than the temperature threshold, the UE may configure the reporting indicator as false or absent and report the same to the gNB. Alternatively, when temperature of the UE or average temperature is higher than the temperature threshold for at least a specific time threshold (tThreshold) value, the UE may configure the reporting indicator as true or present and transmit the same to the gNB. Otherwise, the UE may configure the reporting indicator as false or absent and transmit the same to the gNB.

The temperature threshold and/or a time threshold may be a value configured by the gNB and may be included in the RRC reconfiguration message. For example, the temperature threshold and/or the time threshold may be a value included in OverheatingAssistanceConfig within the RRC reconfiguration message. Alternatively, the temperature threshold and/or the time threshold may be a fixed value defined by the standard. Alternatively, the temperature threshold and/or the time threshold may be a value defined according to specific standard safety specifications (for example, EN563, European safety specifications). Alternatively, the temperature threshold and/or the time threshold may be a value defined by UE implementation (a value varying depending on each UE).

The reporting indicator may be included in the UAI message. For example, the reporting indicator may be included in the OverheatingAssistance IE within the UAI message.

Method 2) The number of temperature thresholds and/or time thresholds may be plural. That is, an overheating degree of the UE may be divided into a plurality of levels. Accordingly, the reporting indicator may also indicate the overheating degree with a plurality of levels.

For example, when the number of temperature thresholds is three (for example, Threshold,1, Threshold,2, and Threshold,3, and Tthreshold,1<Tthreshold,2<Tthreshold,3) and a common time threshold (tthreshold) is configured or defined,

1) The UE may indicate an overheating degree of a first level to the gNB if (average) temperature of the UE is equal to or lower than Threshold,1 for at least tthreshold (for example, indicate 1 in the OverheatingAssistance IE within the UAI message). Alternatively, the UE may not determine overheating and may indicate nothing. That is, the UE may indicate a parameter of absence.

2) The UE may indicate an overheating degree of a second level to the gNB if (average) temperature of the UE is higher than Threshold, 1 and lower than Threshold,2 for at least tthreshold (for example, indicate 2 in the OverheatingAssistance IE within the UAI message).

3) The UE may indicate an overheating degree of a third level to the gNB if (average) temperature of the UE is higher than Threshold,2 and lower than Threshold,3 for at least tthreshold (for example, indicate 3 in the OverheatingAssistance IE within the UAI message).

4) The UE may indicate an overheating degree of a fourth level to the gNB if (average) temperature of the UE is higher than Threshold,3 for at least tthreshold (for example, indicate 4 in the OverheatingAssistance IE within the UAI message).

In another example, when the number of thresholds is three (Tthreshold,1, Tthreshold,2, and Tthreshold,3, and Tthreshold,1<Tthreshold,2<Tthreshold,3) and time thresholds (tthreshold,1, tthreshold,2, tthreshold,3, and tthreshold,4) are configured or defined,

5) The UE may report an overheating degree of a first level to the gNB if (average) temperature of the UE is equal to or lower than Threshold,1 for at least tthreshold,1 (for example, indicate 1 in the OverheatingAssistance IE within the UAI message). Alternatively, the UE may not determine overheating and may indicate nothing. That is, the UE may indicate a parameter of absence.

6) The UE may indicate an overheating degree of a second level to the gNB if (average) temperature of the UE is higher than Threshold, 1 and lower than Threshold,2 for at least tthreshol,2 (for example, indicate 2 in the OverheatingAssistance IE within the UAI message).

7) The UE may indicate an overheating degree of a third level to the gNB if (average) temperature of the UE is higher than Threshold,2 and lower than Threshold,3 for at least tthreshol,3 (for example, indicate 3 in the OverheatingAssistance IE within the UAI message).

8) The UE may indicate an overheating degree of a fourth level to the gNB if (average) temperature of the UE is higher than Threshold,3 for at least tthreshol,4 (for example, indicate 4 in the OverheatingAssistance IE within the UAI message).

Meanwhile, in the embodiment of Method 2, the number of temperature thresholds and time thresholds may vary depending on the configuration.

Method 3) The UE may report a period (overheating detection period) during which temperature of the UE is higher than the temperature threshold. The configuration/definition of the thresholds and the description of the reporting indicator may refer to the description of Methods 1 and 2. The period may be a continuous period during which overheating has occurred. Alternatively, the period may be a sum of periods (even if discontinuous) during which overheating has occurred within a specific observation time (for example, an observation time of 10 minutes) (for example, when discontinuous overheating detection periods within the observation time are 1 second, 3 seconds, and 6 seconds, 10 minutes corresponding to the sum thereof may be reported). Alternatively, a plurality of continuous periods during which overheating has occurred may be reported (for example, when discontinuous overheating detection periods within the observation time are 1 second, 3 seconds, and 6 seconds, 1, 3, and 6 corresponding to sums thereof may be reported).

Method 4) The UE may report the current temperature of the UE (for example, 35 degrees Celsius). Alternatively, the UE may report average temperature of the UE within a specific time interval (for example, an interval of the fixed length variably configured by the network or defined by the standard). The UE may report the temperature through the UAI message.

In an embodiment, the UE may report temperature of the UE when detecting overheating. In another embodiment, although overheating is not detected, the UE may transmit the temperature of the UE. The reason is that the gNB can control the network settings for the UE by using the information (before overheating occurs).

The definition of a parameter in Celsius units used to report UE temperature by the UE may cause the use of many bits in ASN.1 code. Accordingly, the UE may define/report the current temperature of the UE in quantized units. For example, temperature from 0 degrees Celsius to 10 degrees Celsius may be defined as level 1, temperature from 10 degrees Celsius to 20 degrees Celsius may be defined as level 2, temperature from 20 degrees Celsius to 30 degrees Celsius may be defined as level 3, and the level (for example, 1, 2, or 3) may be indicated during the report by the UE.

Method 5) The UE may report target temperature (TTarget) of the UE (for example, 35 degrees Celsius). The UE may report the temperature through the UAI message.

In an embodiment, the UE may report the target temperature of the UE when detecting overheating. In another embodiment, although overheating is not detected, the UE may transmit the target temperature of the UE. The reason is that the gNB can control the network settings for the UE by using the information (before overheating occurs).

The definition of a parameter in Celsius units used to report the target temperature of the UE by the UE may cause the use of many bits in ASN.1 code. Accordingly, the UE may define/report the target temperature in quantized units. For example, temperature from 0 degrees Celsius to 10 degrees Celsius may be defined as level 1, temperature from 10 degrees Celsius to 20 degrees Celsius may be defined as level 2, temperature from 20 degrees Celsius to 30 degrees Celsius may be defined as level 3, and the level (for example, 1, 2, or 3) may be indicated during the report by the UE.

Method 6) According to specific safety specifications (for example, EN563), the UE may report an indicator for the case where overheating is detected to the gNB (in violation thereof). When overheating is detected, the UE may report true or make a report including the corresponding indicator (present). When overheating is not detected, the UE may report false or makes a report without the corresponding indicator (absent).

The gNB may configure the safety specifications that should be used to determine whether overheating occurs in the UE. For example, the gNB may configure safety specifications in the UE by using OverheatingAssistanceConfig within the RRC reconfiguration message. Alternatively, the specific safety specifications may be defined in the standard. Alternatively, there may be specifications used for each UE, and the UE may report the same to the gNB. To this end, the UAI message or the UE capability message may be used.

Method 7) The UE may report preferred specific safety specifications (for example, EN563) to the gNB. The gNB may use reported safety specifications during network settings (for example, settings of the time/temperature thresholds).

### THIRD EMBODIMENT

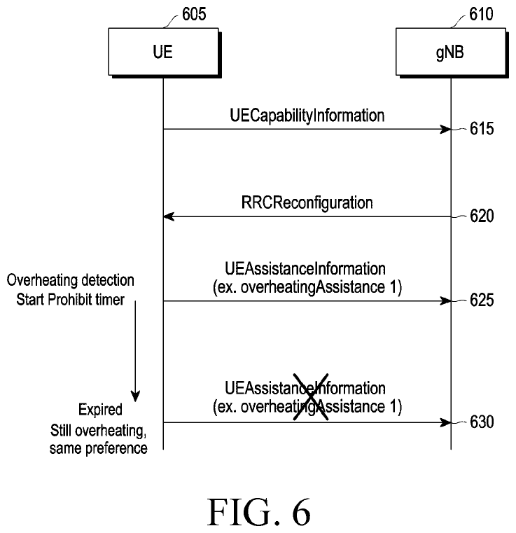

Hereinafter, a third embodiment for UAI enhancement is described with reference to FIGS. 6 to 8.

FIG. 6 is a diagram illustrating a method by which the UE processes the same UAI according to an embodiment of the disclosure.

In the embodiment of FIG. 6, the case where UE assistance information (UAI) is assistance information for informing the gNB of overheating of the UE is described as an example for convenience of description, but the embodiment is not limited thereto and the same description may be applied to UAI for the various UAI features. For example, the same description may be applied to other cases where the UE experience persistent problems (for example, IDC problem, energy waste problem, or the like) like overheating.

Referring to FIG. 6, in operation 615, for an overheating UAI feature, a UE 605 may report whether the overheating UAI feature is supported to a gNB 610 through an indicator (for example, overheatingInd) within the UE capability message.

In operation 620, the gNB 610 may set up or release the overheating UAI feature through configuration information (for example, OverheatingAssistanceConfig), and configure a PT for the overheating UAI feature in the UE 605 (by configuring the length of the PT) during setup. As an embodiment, OverheatingAssistanceConfig may be included in an RRC reconfiguration message.

When overheating is detected or previously transmitted overheating information is changed, the UE 605 receiving the setup of the overheating UAI feature may start running the PT and simultaneously transmit overheating UAI to the gNB 610 in operation 625 if the corresponding PT is not running.

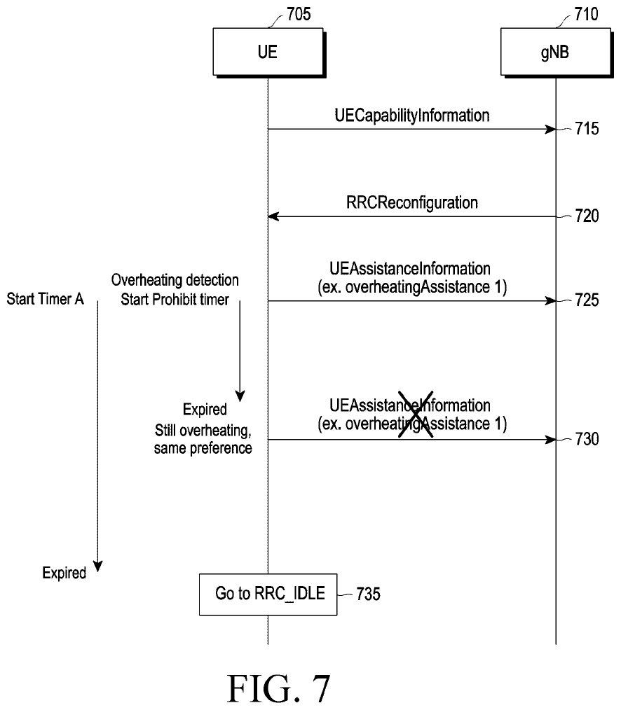

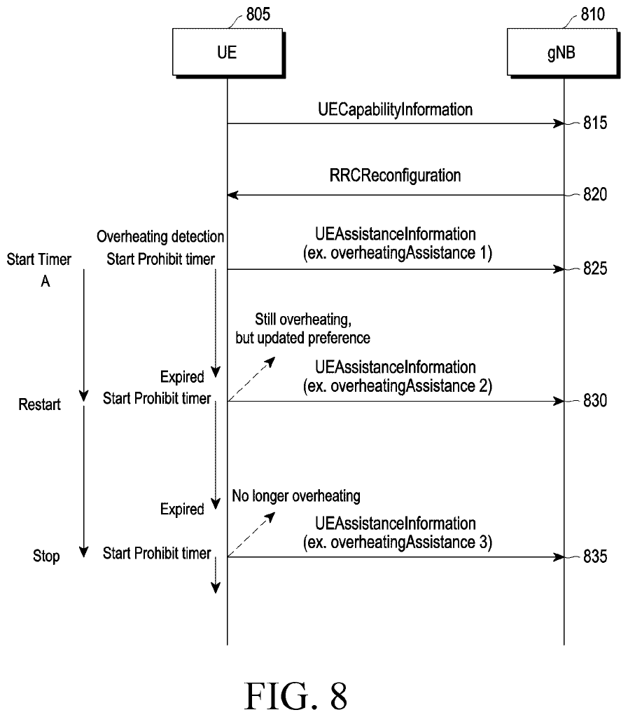

When the UE 605 still detects overheating after the running of the PT expires but overheating-related UAI (overheatingAssistance) transmitted to the gNB 610 is not changed (for example, same preference), the UE 604 may not transmit the UAI message for overheating as illustrated in operation 630. That is, when the current overheating UAI is the same as the previously transmitted overheating UAI (overheating assistance information) even after the running of the PT expires, the UE 605 may not transmit the overheating problem to the gNB 610 anymore. Further, although the gNB 610 is first reported the overheating problem in operation 625, the gNB may ignore and may not take any action (for example, a change in the network settings) on the corresponding UE 605. As a result, the UE 605 may continuously experience the overheating problem. Since such a situation may be a great threat to user's safety, a method by which the UE 605 autonomously transitions to the RRC_IDLE mode (or RRC_INACTIVE) and solve the overheating problem by itself may be defined as an embodiment of the disclosure in order to solve the problems (technical problems). This will be described with reference to examples of FIGS. 7 to 8.

FIG. 7 is a diagram illustrating a procedure in which the UE autonomously transitions to the RRC_IDLE mode (or RRC_INACTIVE) when a timer A expires according to an embodiment of the disclosure.

In the embodiment of FIG. 7, like FIG. 6, the case where UE assistance information (UAI) is assistance information for informing the gNB of overheating of the UE is described as an example for convenience of description, but the embodiment is not limited thereto and the same description may be applied to UAI for the various UAI features. For example, the same description may be applied to other cases where the UE experience persistent problems (for example, IDC problem, energy waste problem, or the like) like overheating.

In the disclosure, the time A may be defined as a timer separated from the PT, and may define an operation to allow the UE to autonomously transition to the RRC_IDLE mode (or RRC_INACTIVE). For example, in the case of the overheating UAI feature, the time A may define the operation to allow the UE to autonomously transition to the RRC_IDLE mode (or RRC_INACTIVE) in the case where the UE still experiences the overheating problem when the corresponding timer expires.

As an embodiment, the timer A may be configured or defined to have a running time longer than the PT. For example, the timer A for the overheating UAI feature may be configured or defined to have the running time longer than the PT for the overheating UAI feature.

As an embodiment, the length of the timer A may be variably configured by the gNB along with the length of the PT or may be the fixed length defined in the standard.

Referring to FIG. 7, in operation 715, for the overheating UAI feature, a UE 705 may report whether the overheating UAI feature is supported to a gNB 710 through an indicator (for example, overheatingInd) within the UE capability message.

Further, the UE 705 may report whether the UE has capability of supporting the timer A or capability of supporting autonomous transition to the RRC_IDLE (or RRC_INACTIVE) for overheating (or overheating UAI feature) of the UE through a new indicator within the UE capability message.

In operation 720, the gNB 710 may set up or release the overheating UAI feature through configuration information (for example, OverheatingAssistanceConfig), and configure a PT for the overheating UAI feature in the UE 705 (by configuring the length of the PT) during setup. As an embodiment, OverheatingAssistanceConfig may be included in an RRC reconfiguration message.

Further, in operation 720, the gNB 710 may configure, in the UE, whether the time A is used or the autonomous transition to RRC_IDLE (or RRC_INACTIVE) is allowed for overheating (or overheating UAI feature) of the UE.

In addition, the gNB 710 may configure an RRC state to which the UE should transition during RRC_IDLE or RRR_INACTIVE.

When overheating is detected or previously transmitted overheating information is changed, the UE 705 receiving the setup of the overheating UAI feature may start running the PT and simultaneously transmit overheating UAI to the gNB if the corresponding PT is not running in operation 725.

Further, when the UAI message according to overheating detection is transmitted (for example, operation 725), the UE 705 may start running the timer A. As an embodiment, the timer A for the overheating UAI feature may start simultaneously with the PT for the overheating UAI feature.

When the UE 705 still detects overheating after the running of the PT expires but overheating-related UAI (overheatingAssistance) to be transmitted to the gNB 710 is not changed (for example, same preference), the UE may not transmit the UAI message for overheating as illustrated in operation 730.

When the timer A expires, the UE 705 may determine whether to transition to RRC_IDLE (or RRC_INACTIVE) by itself as illustrated in operation 735. For example, when the UE still experiences the overheating problem after the time A expires and accordingly the UAI (overheating UAI) to be transmitted to the gNB is not changed from the previously reported information (for example, same preference) or a relevant configuration change is not received from the network, the UE 705 may transition to RRC_IDLE (or RRC_INACTIVE) by itself and solve the overheating problem.

FIG. 8 is a diagram illustrating a procedure in which the UE restarts and terminates the timer A according to an embodiment of the disclosure.

In the embodiment of FIG. 8, like FIGS. 6 and 7, the case where UE assistance information (UAI) is assistance information for informing the gNB of overheating of the UE is described as an example for convenience of description, but the embodiment is not limited thereto and the same description may be applied to UAI for the various UAI features. For example, the same description may be applied to other cases where the UE experience persistent problems (for example, IDC problem, energy waste problem, or the like) like overheating.

Description of operations 805 to 825 of FIG. 8 may refer to the description from operations 705 to 825 of FIG. 7. For example, the content of operations 715 to 735 of FIG. 7 may be equally applied to operations 815 to 835 of FIG. 8 within the scope that they do not contradict the description of FIG. 8 below, and the corresponding description may refer to the description of FIG. 7.

When a UE 805 still detects overheating after the running of the PT expires and overheating-related UAI (overheatingAssistance) to be transmitted to a gNB 810 is changed (for example, updated preference), the UE 805 may transmit the UAI message including the updated information in operation 830. At this time, when the timer A is running, the UE 805 may restart the timer A. The length of the timer A may be a time during which the UE waits for resolution of the overheating (through an action of the network (for example, a change in settings) right after transmitting the UAI.

Since the UE 805 transmitted new UAI in operation 830, the time A may restart, and the UE 805 may wait again from the beginning for the length of the timer A for overheating to be resolved (through the action of the network (for example, the change in settings). In operation 830, when the new UAI message is transmitted, running of the PT may start again.

When the running of the PT expires and the UE does not experience overheating anymore, the UE 805 may transmit the UAI message while the UAI (overheatingAssistance) is absent in operation 835. At this time, the UE 805 may not stop the running of the timer A because there is no longer overheating problem.

Alternatively, when the timer A expires and the UE still experiences the overheating problem, the UE may determine whether to transition to RRC_IDLE (or RRC_INACTIVE) by itself according to, for example, operation 735 of FIG. 7.

As described above, the embodiments of FIGS. 6 to 8 have described the overheating UAI feature as an example for convenience of description, but the content of the disclosure may define the operation in which the UE can transition to RRC_IDLE (or RRC_INACTIVE) by itself and apply the operation to other cases (for example, IDC problem, energy waste problem, and the like) in which the UE experiences the persistent problem.

Further, for convenience of description, some embodiments of the disclosure include the method by which the UE autonomously transitions to RRC_IDLE (or RRC_INACTIVE) to solve the overheating problem, but a method by which the UE removes an Scell by itself may be applied. A method by which the UE deactivates a second cell group (SCG) by itself may be applied. A method by which the UE falls back from NR to LTE by itself may be applied. The UE may report the RRC mode that the UE itself prefers to the gNB in which case a ReleasePreference IE may be reused.

### FOURTH EMBODIMENT

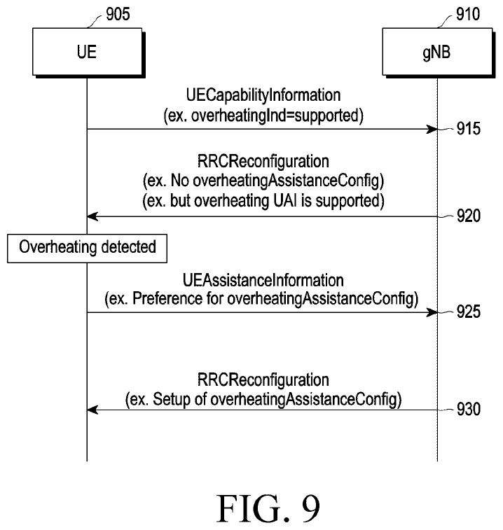

Hereinafter, a fourth embodiment for UAI enhancement is described with reference to FIG. 9.

FIG. 9 is a diagram illustrating a procedure in which the UE transmits a UAI feature for which the UE desires to be configured to the gNB according to an embodiment of the disclosure.

According to the UAI feature as illustrated in FIG. 3, when the UE reports the fact of supporting the corresponding UAI feature to the gNB as illustrated in operation 315 of FIG. 3, and then the gNB provides the UE with the setup of the corresponding UAI feature as illustrated in operation 320 of FIG. 3, the UE may report UAI for the corresponding UAI feature to the gNB as illustrated in operation 325 of FIG. 3. As described above, the UE may report only UAI for the UAI feature configured by the gNB to the gNB. That is, the UE may report only UAI allowed to be transmitted (or reported) by the gNB to the gNB.

However, although a UE 905 reports the fact of supporting the corresponding UAI feature as illustrated in operation 915 of FIG. 9 (or operation 315 of FIG. 3), a gNB 910 may not provide the UE with the setup for the corresponding UAI feature as illustrated in operation 920 of FIG. 9. That is, provision of the setup for the corresponding UAI feature follows determination of the gNB.

In this case, the UE 905 may transfer UE preference (for example, the configuration for power saving) or the problem (for example, overheating or IDC problem) that the UE experience to the gNB 910 and may need configurations of the gNB suitable therefor. To this end, the disclosure proposes a method by the UE 905 makes a request for configuring the corresponding UAI feature to the gNB 910.

In an embodiment, when the UE 905 desires to report the corresponding UAI feature in the state in which there is no setup for the UAI feature (for example, when overheating is detected), the UE may make a request for configuring the corresponding UAI feature (for example, overheating) to the gNB 910. For example, as illustrated in operation 925, the UE 905 may make a request for setting up the corresponding UAI feature configuration (for example, overheating configuration (overheatingAssistanceConfig)) to the gNB through the UAI message. For example, the UE 905 may make a request for the corresponding UAI feature configuration (UAI configuration request) to the gNB 910 by transmitting the UAI message including information (preference information) indicating preference for the corresponding UAI feature configuration (for example, overheating configuration).

In order to allow the UAI configuration request from the UE, the gNB 910 may include and transmit an indicator indicating that the corresponding UAI configuration is allowed to the UE as illustrated in operation 920. For example, the gNB 910 may inform the UE 905 that request for the corresponding UAI feature configuration (UAI configuration) is allowed by transmitting information (indicator) indicating that the overheating UAI feature is supported by the gNB. As an embodiment, the indicator may be included in a system information block (SIB) or an RRC message (for example, RRC reconfiguration message).

In operation 930, the gNB 910 receiving the UAI configuration request may provide the UE 905 with the setup of the UAI configuration according thereto. Alternatively, the gNB 910 may ignore the UAI configuration request from the UE 905.

As an embodiment, in order to prevent a frequent UAI configuration request from the UE, a PT for the UAI configuration request may be defined and may start running in operation 925. That is, the PT may start when transmission of the UAI message including the UAI configuration request is initiated. The UE 905 may not transmit the UAI message for the UAI configuration request while the PT is running.

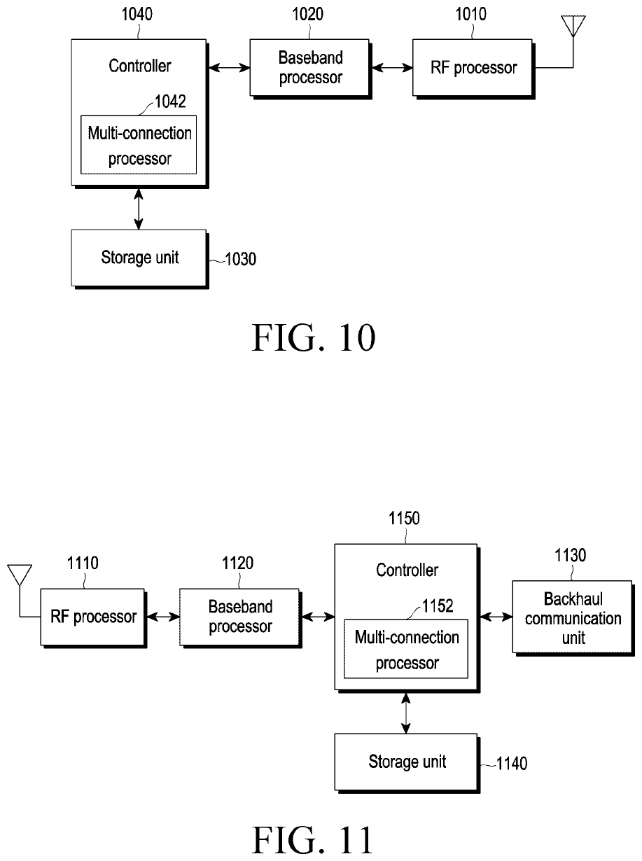

FIG. 10 is a block diagram illustrating a structure of a UE according to an embodiment of the disclosure.

Referring to FIG. 10, the UE may include a radio frequency (RF) processor 1010, a baseband processor 1020, a storage unit 1030, and a controller 1040. The baseband processor 1020 and the RF processor 1010 may transmit and receive signals. Therefore, the baseband processor 1020 and the RF processor 1010 may be referred to as a transmitter, a receiver, a transceiver, or a communication unit.

The RF processor 1010 may perform functions for transmitting/receiving signals through a radio channel, such as signal band conversion and amplification. That is, the RF processor 1010 may up-convert a baseband signal provided from the baseband processor 1020 to an RF band signal, may transmit the same through an antenna, and may down-convert an RF band signal received through the antenna to a baseband signal. For example, the RF processor 1010 may include a transmission filter, a reception filter, an amplifier, a mixer, an oscillator, a digital-to-analog converter (DAC), an analog-to-digital converter (ADC), and the like. Although only one antenna is illustrated in FIG. 10, the UE may include multiple antennas. In addition, the RF processor 1010 may include multiple RF chains. Furthermore, the RF processor 1010 may perform beamforming. For the beamforming, the RF processor 1010 may adjust the phase and magnitude of signals transmitted/received through multiple antennas or antenna elements, respectively. In addition, the RF processor may perform MIMO, and may receive multiple layers when performing a MIMO operation.

The baseband processor 1020 may perform functions of conversion between baseband signals and bitstrings according to the system's physical layer specifications. For example, during data transmission, the baseband processor 1020 may encode and modulate a transmitted bitstring to generate complex symbols. In addition, during data reception, the baseband processor 1020 may demodulate and decode a baseband signal provided from the RF processor 1010 to restore a received bitstring. For example, when following the orthogonal frequency division multiplexing (OFDM) scheme, during data transmission, the baseband processor 1020 may encode and modulate a transmitted bitstring to generate complex symbols, may map the complex symbols to subcarriers, and may configure OFDM symbols through inverse fast Fourier transform (IFFT) operation and cyclic prefix (CP) insertion. In addition, during data reception, the baseband processor 1020 may split a baseband signal provided from the RF processor 1010 at the OFDM symbol level, may restore signals mapped to subcarriers through a fast Fourier transform (FFT) operation, and may restore a received bitstring through demodulation and decoding.

The baseband processor 1020 and the RF processor 1010 may transmit and receive signals as described above. Therefore, the baseband processor 1020 and the RF processor 1010 may be referred to as a transmitter, a receiver, a transceiver, or a communication unit. Furthermore, at least one of the baseband processor 1020 and the RF processor 1010 may include multiple communication modules to support multiple different radio access technologies. In addition, at least one of the baseband processor 1020 and the RF processor 1010 may include different communication modules to process signals in different frequency bands. For example, the different radio access technologies may include wireless LANs (for example, IEEE 802.11), cellular networks (for example, LTE), and the like. In addition, the different frequency bands may include super high frequency (SHF) (e.g., 2 NRHz) bands and millimeter wave (mmWave) (e.g., 60 GHz) bands.

The storage unit 1030 may store data such as basic programs for operation of the UE, application programs, and configuration information. Particularly, the storage unit 1030 may store information regarding a second access node configured to perform wireless communication by using a second radio access technology. In addition, the storage unit 1030 may provide the stored data at the request of the controller 1040.

The controller 1040 controls the overall operation of the UE. For example, the controller 1040 may transmit/receive signals through the baseband processor 1020 and the RF processor 1010. In addition, the controller 1040 records data in the storage unit 1030 and reads the data from the storage unit 1030. To this end, the controller 1040 may include at least one processor. For example, the controller 1040 may include a communication processor (CP) configured to perform control for communication, and an application processor (AP) configured to control upper layers such as application programs.

FIG. 11 is a block diagram illustrating a structure of a base station according to an embodiment of the disclosure.

Referring to FIG. 11, the base station may include an RF processor 1110, a baseband processor 1120, a backhaul communication unit 1130, a storage unit 1140, and a controller 1150. The baseband processor 1120 and the RF processor 1110 transmit and receive signals. Therefore, the baseband processor 1120 and the RF processor 1110 may be referred to as a transmitter, a receiver, a transceiver, or a communication unit.

The RF processor 1110 may perform functions for transmitting/receiving signals through a radio channel, such as signal band conversion and amplification. That is, the RF processor 1110 may up-convert a baseband signal provided from the baseband processor 1120 to an RF band signal, may transmit the same through an antenna, and may down-convert an RF band signal received through the antenna to a baseband signal. For example, the RF processor 1110 may include a transmission filter, a reception filter, an amplifier, a mixer, an oscillator, a DAC, and an ADC. Although only one antenna is illustrated in the drawing, the first access node may include multiple antennas. In addition, the RF processor 1110 may include multiple RF chains. Furthermore, the RF processor 1110 may perform beamforming. For the beamforming, the RF processor 1110 may adjust the phase and magnitude of signals transmitted/received through multiple antennas or antenna elements, respectively. The RF processor may transmit one or more layers to perform a downward MIMO operation.

The baseband processor 1120 may perform functions of conversion between baseband signals and bitstrings according to the physical layer specifications of first radio access technology. For example, during data transmission, the baseband processor 1120 may encode and modulate a transmitted bitstring to generate complex symbols. In addition, during data reception, the baseband processor 1120 may demodulate and decode a baseband signal provided from the RF processor 1110 to restore a received bitstring. For example, when following the OFDM scheme, during data transmission, the baseband processor 1120 may encode and modulate a transmitted bitstring to generate complex symbols, may map the complex symbols to subcarriers, and may configure OFDM symbols through IFFT operation and CP insertion. In addition, during data reception, the baseband processor 1120 may split a baseband signal provided from the RF processor 1110 at the OFDM symbol level, may restore signals mapped to subcarriers through FFT operation, and may restore a received bitstring through demodulation and decoding. The baseband processor 1120 and the RF processor 1110 transmit and receive signals as described above. Therefore, the baseband processor 1120 and the RF processor 1110 may be referred to as a transmitter, a receiver, a transceiver, or a communication unit.

The backhaul communication unit 1130 provides an interface for communicating with other nodes in the network. That is, the backhaul communication unit 1130 converts bitstrings transmitted from the main base station to other nodes, for example, an auxiliary base station, a core network, etc., into physical signals, and converts physical signals received from the other nodes into bitstrings.

The storage unit 1140 may store data such as basic programs for operation of the main base station, application programs, and configuration information. Particularly, the storage unit 1140 may store information regarding a bearer allocated to a connected UE, a measurement result reported from the connected UE, and the like. In addition, the storage unit 1140 may store information serving as a reference to determine whether to provide multi-connection to a UE or to suspend the same. In addition, the storage unit 1140 may provide the stored data at the request of the controller 1150.

The controller 1150 controls the overall operation of the main base station. For example, the controller 1150 transmits/receives signals through the baseband processor 1120 and the RF processor 1110 or through the backhaul communication unit 1130. In addition, the controller 1150 records data in the storage unit 1140 and reads the data from the storage unit 1140. To this end, the controller 1150 may include at least one processor.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. A method performed by a user equipment (UE) in a wireless communication system, the method comprising:
transmitting, to a base station, capability information on support for a report of first UE assistance information (UAI);
receiving, from the base station, first configuration information for reporting the first UAI; and
reporting, to the base station, the first UAI based on the first configuration information, and starting a first prohibit timer related to the reporting of the first UAI.

2. (canceled)

3. The method of claim 1, further comprising:
before the first prohibit timer expires, transmitting, to the base station, a second UAI including preference information on a length of a second prohibit timer;
receiving, from the base station, second_configuration information for the length of the second prohibit timer; and
after the first prohibit timer expires, reporting, to the base station, a third UAI and starting the second prohibit timer based on the second configuration information.

4. The method of claim 1, further comprising:
starting a third prohibit timer related to autonomous transition of the UE to a radio resource control (RRC) idle mode or an RRC inactive mode, along with starting the first prohibit timer,
wherein, in case that the first UAI is for overheating of the UE, the first UAI comprises information indicating a degree of overheating of the UE.

5. A user equipment (UE) in a wireless communication system, the UE comprising:
a transceiver; and
at least one processor, wherein the at least one processor is configured to:
transmit, to a base station, capability information on support for a report of first user equipment (UE) assistance information (UAI);
receive, from the base station, first configuration information for reporting the first UAI; and
report, to the base station, the first UAI based on the first configuration information, and start a first prohibit timer related to the reporting of the first UAI.

6. (canceled)

7. The UE of claim 5, wherein the at least one processor is further configured to:
before the first prohibit timer expires, transmit, to the base station, a second UAI including preference information on a length of a second prohibit timer,
receive, from the base station, second_configuration information for the length of the second prohibit timer, and
after the first prohibit timer expires, report, to the base station, a third UAI and start the second prohibit timer based on the second configuration information.

8. The UE of claim 5, wherein the at least one processor is further configured to:
start a third prohibit timer related to autonomous transition of the UE to a radio resource control (RRC) idle mode or an RRC inactive mode, along with starting the first prohibit timer,
wherein, in case that the first UAI is for overheating of the UE, the first UAI comprises information indicating a degree of overheating of the UE.

9. A method performed by a base station in a wireless communication system, the method comprising:
receiving, from a user equipment (UE), capability information on support for a report of first UE assistance information (UAI);
transmitting, to the UE, first configuration information for reporting the first UAI; and
receiving, from the UE, the first UAI based on the first configuration information,
wherein a first prohibit timer related to the reporting of the first UAI starts in case that a first UAI message is reported.

10. The method of claim 9, wherein, in case that the first UAI is for overheating of the UE, the first UAI comprises information indicating a degree of overheating of the UE.

11. The method of claim 9, further comprising:
before the first prohibit timer expires, receiving, from the UE, a second UAI including preference information on a length of a second prohibit timer;
transmitting, to the UE, second configuration information for the length of the second prohibit timer; and
after the first prohibit timer expires, receiving, from the UE, a third UAI,
wherein the second prohibit timer starts based on the second configuration information in case that the third UAI is reported.

12. A base station in a wireless communication system, the base station comprising:
a transceiver; and
at least one processor, wherein the at least one processor is configured to:
receive, from a user equipment (UE), capability information on support for a report of first UE assistance information (UAI),
transmit, to the UE, first configuration information for reporting the first UAI, and
receive, from the UE, the first UAI based on the first configuration information,
wherein a first prohibit timer related to the reporting of the first UAI starts in case that a first UAI message is reported.

13. The base station of claim 12, wherein, in case that the first UAI is for overheating of the UE, the first UAI comprises information indicating a degree of overheating of the UE.

14. The base station of claim 12, wherein the at least one processor is configured to:
before the first prohibit timer expires, receive, from the UE, a second UAI including preference information on a length of second prohibit timer,
transmit, to the UE, second_configuration information for the length of the second prohibit timer, and
after the first prohibit timer expires, receive, from the UE, a third UAI,
wherein the second prohibit timer starts based on the second configuration information in case that the third UAI is reported.

15. The method of claim 1, wherein the capability information includes information on support for a report of preference information for a length of a prohibit timer related to the first UAI.

16. The method of claim 3, wherein the preference information on the length of the second prohibit timer comprises information indicating a preferred length of the second prohibit timer or information indicating whether the preferred length of the second prohibit timer is shorter or longer than a length of the first prohibit timer.

17. The UE of claim 5, wherein the capability information includes information on support for a report of preference information for a length of a prohibit timer related to the first UAI.

18. The UE of claim 7, wherein the preference information on the length of the second prohibit timer comprises information indicating a preferred length of the second prohibit timer or information indicating whether the preferred length of the second prohibit timer is shorter or longer than a length of the first prohibit timer.

19. The method of claim 9, wherein the capability information includes information on support for a report of preference information for a length of a prohibit timer related to the first UAI.

20. The method of claim 11, wherein the preference information on the length of the second prohibit timer comprises information indicating a preferred length of the second prohibit timer or information indicating whether the preferred length of the second prohibit timer is shorter or longer than a length of the first prohibit timer.

21. The based station of claim 12, wherein the capability information includes information on support for a report of preference information for a length of a prohibit timer related to the first UAI.

22. The based station of claim 14, wherein the preference information on the length of the second prohibit timer comprises information indicating a preferred length of the second prohibit timer or information indicating whether the preferred length of the second prohibit timer is shorter or longer than a length of the first prohibit timer.
